(19) United States
(12) Patent Application Publication
(10) Pub. No.: US 2019/0106615 A1
(43) Pub. Date: Apr. 11, 2019

(54) CONTROLLING PRODUCTION OF WATER IN SUBTERRANEAN FORMATIONS

(71) Applicant: Halliburton Energy Services, Inc., Houston, TX (US)

(72) Inventors: Sairam Eluru, Pune, Maharashtra (IN); Nurpasha Jahangir Hipparge, Pune, Maharashtra (IN); Pratiksha Shivaji Meher, Pune, Maharashtra (IN)

(21) Appl. No.: 15/743,144

(22) PCT Filed: Aug. 11, 2015
(86) PCT No.: PCT/US2015/044692

§ 371 Date: Jan. 9, 2018

(51) Int. Cl. C09K 8/502; C09K 8/512; C09K 8/514; C09K 8/64; C09K 8/68; C09K 8/76; C09K 8/82; C09K 8/88; C09K 8/90

(52) U.S. Cl. CPC C09K 8/502; C09K 8/512; C09K 8/514; C09K 8/64; C09K 8/90; C09K 8/76; C09K 8/82; C09K 8/887; C09K 8/685

(57) ABSTRACT

Methods, compositions, and systems that may be used for the selective reduction of water permeability of subterranean formations using hydrogel polymer materials are provided. An embodiment of the present disclosure is a method comprising: providing a treatment fluid comprising a carrier fluid and a hydrogel polymer comprising the reaction product of a polysaccharide and a derivative of acrylic acid; and introducing the treatment fluid into a wellbore that penetrates at least a portion of a subterranean formation.

### BACKGROUND

The present disclosure relates to methods, compositions, and systems for treating subterranean formations. In particular, the present disclosure relates to the selective reduction of water permeability of subterranean formations.

Natural resources such as oil or gas residing in a subterranean formation can be recovered by drilling a wellbore that penetrates the formation. As used herein, the term “formation” refers to a region having similar geological characteristics, including the presence of particular formation fluids. The wellbore passes through a variety of subterranean formations. This may include reservoir zones (i.e., formations that contain oil or gas) and non-reservoir zones (i.e., formations that do not contain oil and gas).

After the wellbore has been drilled, the well is completed. The completion process includes the steps of preparing the drilled wellbore for the production of hydrocarbons. The completion process may include, for example, inserting production tubing into the wellbore, perforating the production tubing, stimulating the reservoir zones (e.g., acidizing or fracturing), etc. In general, a goal of the completion process may be to fluidly connect the wellbore to the reservoir zones (to allow hydrocarbons, such as oil and gas, to be produced) while isolating the wellbore from the non-reservoir zones (to prevent non-hydrocarbon formation fluids, such as water, from being produced). After a well has been completed, it may produce hydrocarbons for a period of months or even years.

In some situations, non-reservoir zones may contain water instead of oil and gas. Because water is capable of flowing through the formation under appropriate conditions, its presence can sometimes interfere with other activities being carried on within the wellbore. In one example, water can flow into the in-progress wellbore and interfere with the drilling and/or completion operations. Therefore, it can be important to minimize the flow of water from water-producing zones while the wellbore is being drilled and completed.

The presence of water-producing zones can also be detrimental to completed wells. For example, while a well remains in production, the formation fluids in the reservoir zones may change over time because the permeability of various zones in the formation may vary considerably. Over time, the hydrocarbon may be produced from higher permeability zones sooner than from lower permeability zones, and the higher permeability zones may then begin to produce water. In the recovery of hydrocarbons through a shaft or well drilled into the formation, water may flow from the formation into the well, thereby reducing the hydrocarbon production. Excessive water flow may render hydrocarbon production uneconomical, or may reduce reservoir pressure to such an extent that hydrocarbon recovery is not possible.

### BRIEF DESCRIPTION OF THE DRAWINGS

These drawings illustrate certain aspects of some of the embodiments of the present disclosure, and should not be used to limit or define the claims.

FIG. 1 is a diagram illustrating an example of a system that may be used in accordance with certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF CERTAIN EMBODIMENTS

The present disclosure relates to methods, compositions, and systems for treating subterranean formations. In particular, the present disclosure relates to the selective reduction of water permeability of subterranean formations using hydrogel polymer materials.

Generally speaking, the present disclosure provides methods, compositions, and systems for selectively reducing the permeability of a subterranean formation to water or other aqueous fluids. The techniques of the present disclosure involve introducing a treatment fluid into a subterranean formation. The treatment fluid generally comprises a carrier fluid and a hydrogel polymer. According to certain methods of the present disclosure, the treatment fluid infiltrates the permeable portions of a water-producing zone in the subterranean formation and forms a physical barrier that substantially prevents water from entering the wellbore or being produced to the surface. This may prevent a potential influx of water into the wellbore from interfering with drilling or completion operations. It may also facilitate the ongoing production of hydrocarbons from other zones after a well has been completed. According to other methods of the present disclosure, the treatment fluid may be used as an acid diverter in connection with acidizing operations.

In certain embodiments, the treatment fluid may form a gel. As used herein, the term “gel” refers to a fluid with a viscosity from about 1 cP to about 1,000,000 cP. In some embodiments, the treatment fluid has a relatively low viscosity while it is being introduced into the subterranean formation, and the treatment fluid viscosities and forms a gel after it has been placed in the subterranean formation. In other embodiments, the treatment fluid may have a relatively high viscosity while it is being introduced into the subterranean formation.

Without limiting the disclosure to any particular theory or mechanism, it is believed that certain hydrogel polymers are capable of swelling in the range of about 10 to about 1,000 times their original size when they contact water under appropriate conditions. When the hydrogel polymer swells, it creates a physical barrier that prevents the flow of fluid. Because the hydrogel polymer is introduced into the subterranean formation using a base fluid that comprises a non-aqueous fluid, an acidic fluid, and/or a brine, the hydrogel polymer does not significantly swell until it has come into contact with water in the subterranean formation. This allows the treatment fluid to selectively treat regions of the subterranean formation, for example, by swelling in a water-producing zone and by not swelling in a hydrocarbon-producing zone. Similarly, the treatment fluid may be used as an acid diverter by selectively swelling under certain pH conditions.

Among the many potential advantages to the methods, compositions, and systems of the present disclosure, only some of which are alluded to herein, the methods, compositions, and systems of the present disclosure may facilitate the treatment of a subterranean zone or remediation of a well by providing improved compositions and methods to seal water-producing zones. Because the methods, compositions, and systems of the present disclosure selectively reduce water permeability, they may help in enhancement of hydrocarbon recovery by reducing the flow of water into a shaft or well without resulting in a corresponding reduction of the flow of hydrocarbons into the shaft or well. Use of the disclosed techniques thereby may permit more efficient hydrocarbon recovery operations. The methods, compositions, and systems of the present disclosure also may be used to selectively divert acids to enhance the efficacy of acidizing operations.

The treatment fluid used in the methods, compositions, and systems of the present disclosure comprises a carrier fluid. The carrier fluid may also be referred to as a “base fluid,” a term which refers to the major component of the fluid (as opposed to components dissolved and/or suspended therein), and does not indicate any particular condition or property of that fluid such as its mass, amount, pH, etc. Carrier fluids suitable for use according to the methods, compositions, and systems of the present disclosure include fluids that do not result in substantial swelling of the hydrogel polymer, such as non-aqueous fluids, acidic fluids, and brines. In certain embodiments, the density of the carrier fluid can be adjusted, among other purposes, to provide additional particulate transport and suspension in the compositions of the present disclosure. In certain embodiments, the pH of the carrier fluid may be adjusted (e.g., by a buffer or other pH adjusting agent) to a specific level, which may depend on, among other factors, the types of viscosifying agents, acids, and other additives included in the fluid. One of ordinary skill in the art, with the benefit of this disclosure, will recognize when such density and/or pH adjustments are appropriate.

Non-aqueous fluids that may be suitable carrier fluids for use in the methods, compositions, and systems of the present disclosure may include any non-aqueous fluid. In general, the non-aqueous fluid is chosen so that the hydrogel polymer does not swell when it is transported in the non-aqueous carrier fluid. In some embodiments, the fluid carrier may be an aliphatic or aromatic petroleum derivative or an alcohol of low molecular weight, and may comprise a fluid such as gasoline or low viscosity diesel fuel, toluene, or methanol.

Brines that may be suitable carrier fluids for use in the methods, compositions, and systems of the present disclosure may include any saturated salt water. The brine may comprise water from any source. In most embodiments of the present disclosure, the brine comprises one or more ionic species, such as those formed by salts dissolved in water. In general, the hydrogel polymer swells substantially less in an aqueous brines than it does in other aqueous solutions.

In certain embodiments, acidic fluids may be suitable carrier fluids for use in the methods, compositions, and systems of the present disclosure. These include embodiments where the hydrogel polymer does not substantially swell under acidic conditions.

The treatment fluid used in the methods, compositions, and systems of the present disclosure further comprises a hydrogel polymer. The hydrogel polymer may be naturally-occurring or synthetic. The hydrogel polymer used in the treatment fluids comprises a polymer or copolymer that will swell or absorb water when contacted by water-containing solutions of the type that exist in the formation to be treated in accordance with the methods, compositions, and systems of the present disclosure. Swelling properties of these hydrogel polymers depend on factors like cross-linker concentration, monomer, pH, initiator concentration, temperature and salinity. Because water in many subterranean formations exists in the form of aqueous brines, suitable hydrogel polymers include those that swell in response to aqueous solutions of group IA or IIA metals (as applicable) and having a pH comparable to that of the water produced by the formation.

The hydrogel polymer used in the methods, compositions, and systems of the present disclosure comprises the reaction product of a polysaccharide and a derivative of acrylic acid. In some embodiments, the derivative of acrylic acid may be a derivative of sodium acrylate. In certain embodiments, the reaction product may be prepared by the following steps: First, an initiator may be decomposed by heating it to produce sulfate anion radicals. Suitable initiators include, but are not limited to, ammonium persulfate, hydroxymethane sulfinic acid monosodium salt dehydrate, potassium persulfate, and sodium persulfate. Second, the sulfate anion radicals may be used to remove the hydrogen from an —OH group present on a polysaccharide to form a polysaccharide with an active radical site. Third, the polysaccharide with the active radical site may be reacted with monomers of the derivative of acrylic acid. In this embodiment, the radical site of the polysaccharide may initiate a chain reaction of the monomers of the derivative of acrylic acid to form a polymer chain. During the polymerization reaction, a cross-linker may be used to form a polymeric network.

Examples of suitable polysaccharides include, but are not limited to, alginate, chitosan, cellulose, pectin, dextrin, starch, glycogen, and combinations thereof. Examples of suitable derivatives of acrylic acid include any compound of the form R′₂C═CH—COOR, where R can be hydrogen or sodium and R′ can be hydrogen or any organic functional group. In certain embodiments, the hydrogel polymer may comprise derivatives of alginate, such as sodium alginate-g-poly(sodium acrylate) and sodium alginate-g-poly(acrylic acid)/sodium humate. In other embodiments, the hydrogel polymer may comprise derivatives of chitosan, such as chitosan-g-poly (acrylic acid-co-acrylonitrile) and poly(acrylic acid-co-acrylamide) grafted on chitosan.

In some embodiments, the hydrogel polymer may further comprise polyvinyl pyrrolidone. In certain embodiments, the polyvinyl pyrrolidone may be woven into the reaction product's polymer network and held in place with hydrogen bonds. In these embodiments, the polyvinyl pyrrolidone does not take part in the polymerization reaction but interpenetrates and combines with the network through the hydrogen bonding. The inclusion of polyvinyl pyrrolidone in the hydrogel can, among other effects, increase the ability of the hydrogel to swell in the presence of water.

The hydrogel polymer may have a particle size and a molecular weight that depend on the number of monomers incorporated into the chain. Polymers with a relatively high molecular weight may be useful in embodiments where the treatment fluid is used to treat a subterranean formation that has been fractured. Without being limited by theory, it is believed that polymers with a relatively high molecular weight tend to stay in the open space of the fracture and may be more resistant to moving into the matrix. In certain embodiments, hydrogel polymers having a particle size between about 1 mm and about 4 mm may be suitable when the flow rate is greater than about 1 barrel per minute. In other embodiments, hydrogel polymers having a particle size between about 100/300 mesh or 300/400 mesh may be suitable when the flow rate is less than about 1 barrel per minute.

The concentration of the hydrogel polymer in the treatment fluid may vary depending on the circumstances. For example, polymers with relatively higher molecular weights may be used at relatively lower concentrations. In some embodiments, the polymer may be present in the treatment fluid in a concentration of about 50 pounds of material per 1000 gallons of carrier fluid to about 1000 pounds of material per 1000 gallons of carrier fluid. In other embodiments, the polymer may be present in the treatment fluid in a concentration of about 200 pounds of material per 1000 gallons of carrier fluid to about 400 pounds of material per 1000 gallons of carrier fluid. In other embodiments, the polymer may be present in the treatment fluid in a concentration of about 250 pounds of material per 1000 gallons of carrier fluid to about 350 pounds of material per 1000 gallons of carrier fluid.

In certain embodiments, the treatment fluids used in the methods, compositions, and systems of the present disclosure optionally may comprise any number of additional additives. Examples of such additional additives include, but are not limited to, salts, surfactants, acids, diverting agents, fluid loss control additives, gas, nitrogen, carbon dioxide, surface modifying agents, foamers, corrosion inhibitors, catalysts, clay control agents, biocides, friction reducers, antifoam agents, bridging agents, H₂S scavengers, CO₂ scavengers, oxygen scavengers, lubricants, viscosifiers, breakers, weighting agents, relative permeability modifiers, wetting agents, filter cake removal agents, antifreeze agents (e.g., ethylene glycol), and the like. A person skilled in the art, with the benefit of this disclosure, will recognize the types of additives that may be included in the treatment fluids of the present disclosure for a particular application.

The present disclosure in some embodiments provides methods for using the treatment fluids to carry out a variety of subterranean treatments, including but not limited to, treating completed wells, wellbores that are in the process of being drilled and/or completed, and/or subterranean formations. In certain embodiments, a treatment fluid may be introduced into a subterranean formation. In some embodiments, the treatment fluid may be introduced into a completed well or a wellbore that penetrates a subterranean formation. In some embodiments, the treatment fluids of the present disclosure may be used in treating a portion of a well and/or subterranean formation, for example, in sealing off a water-producing zone of the subterranean formation from the well or the wellbore. In these embodiments, the treatment fluid forms a physical barrier that prevents water from the water-producing zones from entering the wellbore.

As noted above, the hydrogel polymer used according to embodiments of the present disclosure is capable of selectively swelling when it contacts water. This allows the treatment fluid of the present disclosure to be used to selectively treat zones within the well and/or subterranean formation. For example, if the treatment fluid is introduced into a water-producing zone, the hydrogel polymer will contact the water and swell thereby sealing the water-producing zone. However, if the treatment fluid comes into contact with a hydrocarbon-producing zone, the hydrogel will not swell. As a result, the treatment fluid does not seal off the hydrocarbon-producing zone.

In certain embodiments, the treatment fluid of the present disclosure is used to treat a well that has begun producing water. This may occur after the well has been completed and production has begun; however, in certain embodiments, a well can be treated by this method during the drilling or completion process. In one embodiment, the method of remediating a completed well takes place in a well that has been cased, but the method may be performed in a cased or an uncased section of the well. In certain embodiments, the purpose of the remediation treatment is to fix the well after it starts producing water so that it produces hydrocarbons again.

In particular, in one embodiment, the following steps may be used to treat a well using the treatment fluid of the present disclosure. First, the location of the water-producing zone of the well is determined using methods known in the art. Second, the water-producing zone of the well is isolated. This can be accomplished by any technique known in the art including, but not limited, to the use of coiled tubing and/or packers. Third, the treatment fluid of the present disclosure is pumped into the water-producing zone. In certain embodiments, the treatment fluid may be pumped through the coiled tubing used to set the packer. Fourth, after the treatment fluid has set in place (e.g., formed a gel) in the water-producing zone of the well, the packers (or other isolation devices) are removed from the well. Finally, hydrocarbon production is resumed.

In some embodiments, the treatment fluid of the present disclosure may be used to seal off a water producing zone even when the location is not known. In these embodiments, the treatment fluid may be introduced into the well without identifying the location of water-producing zone. However, the treatment fluid may selectively interact with the water-producing zone while bypassing non-water producing zones because of the properties of the hydrogel polymer. In particular, the hydrogel may swell when it reaches a water-producing zone after passing through non-water producing zones without swelling.

In several embodiments, the treatment fluid of the present disclosure may be used as an acid diverter that can be used in conjunction with acidizing. The methods disclosed herein may be used, for example, in connection with treating a carbonate/dolomite formation that has a solubility of above 85% in acid and either a gas permeability greater than about 1 millidarcy or an oil permeability greater than about 10 millidarcies. Certain of the hydrogel polymers used in the treatment fluids of the present disclosure (e.g., alginate derivatives) exhibits different swelling characteristics at different pH levels. This particular behavior of the hydrogel polymers may make them suitable candidates to use as a diverter in acidizing.

In the acidizing operations of the present disclosure, a variety of acids may be chosen depending on the temperature conditions or formation mineralogy. In certain embodiments, the acids may be hydrochloric acid or any organic acid. The process will be similar regardless of the acid selected. However, the starting pH of the hydrochloric acid will generally be in the range of about 0 to about 1 while the starting pH of the organic acid will generally be in the range of about 2 to about 3.

In these acidizing embodiments, the hydrogel polymers in the treatment fluid of the present disclosure may be introduced into the subterranean formation (i.e., where the acidizing is to be performed) in different ways. As a first option, the hydrogel polymers may be introduced into the subterranean formation along with acid itself (as the swelling capacity of them is very low at low pH conditions). As a second option, the hydrogel polymers may be introduced into the subterranean formation using a non-aqueous or a brine carrier fluid prior to introducing the acid into the subterranean formation.

According to the first option, a treatment fluid comprising a hydrogel polymer and a carrier fluid with a low pH may be prepared according to the teachings of the present disclosure. The carrier fluid may be prepared with either hydrochloric acid or an organic acid to lower its pH. In this embodiment, the carrier fluid itself may be used itself to acidize the formation. The treatment fluid may be introduced into a subterranean formation that will be acidized (e.g., a carbonate/dolomite formation). In the subterranean formation (where acidizing is performed) there will be different zones including, for example, high permeable zones and low permeable zones. The treatment fluid will generally flow to high permeable zones first because that is the less resistant path. As the treatment fluid contacts the carbonate/dolomite formation, it reacts and the pH of the carrier fluid increases. As the pH start rising, the swelling character of the hydrogel polymer increases. Once the pH of carrier fluid comes to the range of about 3-4, the hydrogel polymer swells and blocks the high permeable zone. In this way, it diverts any additional treatment fluid (including the acidic carrier fluid) from high permeable zone to low permeable zone.

According to the second option, a treatment fluid comprising a hydrogel polymer and a non-aqueous or a brine carrier fluid may be prepared according to the teachings of the present disclosure. The treatment fluid may be introduced into a subterranean formation that will be acidized. Then, the subterranean formation may be treated with an acid. In different embodiments, the acid may be an aqueous acid or an emulsion acid. As the formation is treated, the carbonate/dolomite formation neutralizes the acid which increases its pH. As the pH increases, the hydrogel polymer swells when it contacts the spent acid. The swelling of the hydrogel polymer diverts the rest of the acid into low permeable zones in the subterranean formation.

In another embodiment, the treatment fluid of the present disclosure may be used as a heat insulating medium near the wellbore. In these embodiments, the hydrogel may absorb fluids that otherwise flow around the shaft and transfer heat. Providing heat insulation properties may be useful, inter alia, to reduce the likelihood of paraffin or asphaltene precipitation.

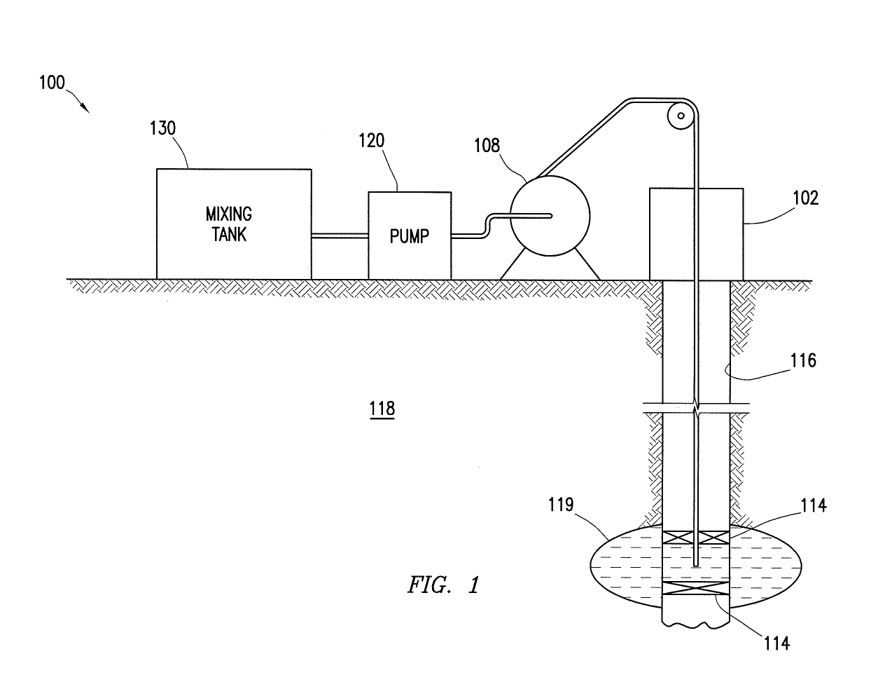

The examples of treatment fluids disclosed herein may directly or indirectly affect one or more components or pieces of equipment associated with the preparation, delivery, recapture, recycling, reuse, and/or disposal of the disclosed treatment fluids. For example, and with reference to FIG. 1, the disclosed treatment fluids may directly or indirectly affect one or more components or pieces of equipment associated with an exemplary assembly 100, according to one or more embodiments. It should be noted that while FIG. 1 generally depicts a land-based assembly, those skilled in the art will readily recognize that the principles described herein are equally applicable to subsea operations that employ floating or sea-based platforms and rigs, without departing from the scope of the disclosure.

As illustrated, the assembly 100 may include a wellhead 102 placed above a wellbore 116 that penetrates various subterranean formations 118. The wellbore 116 may be cased or uncased. If the wellbore 116 has been cased, then the casing will typically be perforated at one or more locations in the subterranean formation 118. The subterranean formations 118 may include one or more water-producing zones 119. The assembly may also include coiled tubing 108, a pump 120, and a mixing tank 130. The mixing tank 130 may include, but is not limited to, mixers and related mixing equipment known to those skilled in the art.

In operation, the coiled tubing 108 may be used to place packers 114 above and below a zone that is desired to be treated, such as water-producing zone 119. The packers 114 serve to isolate the water-producing zone 119 for treatment. A treatment fluid according to the present disclosure may be prepared at the surface in the mixing tank 130. The pump 120 introduces the treatment fluid through the coil tubing 108 into the isolated water-producing zone 119. After the treatment fluid has been introduced into the water-producing zone 119, the packers 114 may be removed and the coil tubing retracted from the wellbore 116. The treatment fluid remains and seals the water-producing zone 119.

As mentioned above, the disclosed treatment fluid may directly or indirectly affect the components and equipment of the assembly 100. For example, the disclosed treatment fluid may directly or indirectly affect the mixing tank 130. The mixing tank 130 may further include one or more sensors, gauges, pumps, compressors, and the like used store, monitor, regulate, and/or recondition the exemplary treatment fluid. The disclosed treatment fluid may directly or indirectly affect the pump 120, which representatively includes any conduits, pipelines, trucks, tubulars, and/or pipes used to fluidically convey the treatment fluid downhole, any pumps, compressors, or motors (e.g., topside or downhole) used to drive the treatment fluid into motion, any valves or related joints used to regulate the pressure or flow rate of the treatment fluid, and any sensors (e.g., pressure, temperature, flow rate, etc.), gauges, and/or combinations thereof, and the like.

While not specifically illustrated herein, the disclosed treatment fluid may also directly or indirectly affect any transport or delivery equipment used to convey the treatment fluid to the assembly 100 such as, for example, any transport vessels, conduits, pipelines, trucks, tubulars, and/or pipes used to fluidically move the treatment fluid from one location to another, any pumps, compressors, or motors used to drive the treatment fluid into motion, any valves or related joints used to regulate the pressure or flow rate of the treatment fluid, and any sensors (i.e., pressure and temperature), gauges, and/or combinations thereof, and the like.

An embodiment of the present disclosure is a method comprising: providing a treatment fluid comprising a carrier fluid and a hydrogel polymer comprising the reaction product of a polysaccharide and a derivative of acrylic acid; and introducing the treatment fluid into a wellbore that penetrates at least a portion of a subterranean formation. Optionally, the subterranean formation comprises a water-producing zone. Optionally, the method further comprises placing the treatment fluid in the water-producing zone. Optionally, the hydrogel polymer further comprises polyvinyl pyrrolidone. Optionally, the polysaccharide comprises a polysaccharide selected from the group consisting of: alginate, chitosan, cellulose, pectin, dextrin, starch, glycogen, and any combination thereof. Optionally, the carrier fluid comprises a fluid selected from the group consisting of: a non-aqueous fluid, a brine, and any combination thereof Optionally, the treatment fluid is introduced in the wellbore using one or more pumps. Optionally, the method further comprises the step of introducing an acid into the wellbore after the step of introducing the treatment fluid into the wellbore. Optionally, the treatment fluid further comprises an acid.

Another embodiment of the present disclosure is a method comprising: providing a treatment fluid comprising a carrier fluid and a hydrogel polymer comprising the reaction product of a polysaccharide and a derivative of acrylic acid, wherein the hydrogel polymer further comprises polyvinyl pyrrolidone; and introducing the treatment fluid into a wellbore that penetrates at least a portion of a subterranean formation, wherein the subterranean formation comprises a water-producing zone.

Another embodiment of the present disclosure is a composition comprising: a carrier fluid comprising a fluid selected from the group consisting of: an acid, a non-aqueous fluid, a brine, and any combination thereof; and a hydrogel polymer comprising the reaction product of a polysaccharide and a derivative of acrylic acid. Optionally, the hydrogel polymer further comprises polyvinyl pyrrolidone. Optionally, the polysaccharide comprises a polysaccharide selected from the group consisting of: alginate, chitosan, cellulose, pectin, dextrin, starch, glycogen, and any combination thereof. Optionally, the polysaccharide comprises a polysaccharide selected from the group consisting of: alginate, chitosan, cellulose, pectin, dextrin, starch, glycogen, and any combination thereof. Optionally, the hydrogel polymer further comprises a cross-linker. Optionally, the treatment fluid has a pH that is less than about 3.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
providing a treatment fluid comprising a carrier fluid and a hydrogel polymer comprising the reaction product of a polysaccharide and a derivative of acrylic acid; and
introducing the treatment fluid into a wellbore that penetrates at least a portion of a subterranean formation.

2. The method of claim 1 wherein the subterranean formation comprises a water-producing zone.

3. The method of claim 2, further comprising placing the treatment fluid in the water-producing zone.

4. The method of claim 1 wherein the hydrogel polymer further comprises polyvinyl pyrrolidone.

5. The method of claim 1 wherein the polysaccharide comprises a polysaccharide selected from the group consisting of: alginate, chitosan, cellulose, pectin, dextrin, starch, glycogen, and any combination thereof.

6. The method of claim 1 wherein the carrier fluid comprises a fluid selected from the group consisting of: a non-aqueous fluid, a brine, and any combination thereof.

7. The method of claim 1 wherein the treatment fluid is introduced in the wellbore using one or more pumps.

8. The method of claim 1 further comprising the step of introducing an acid into the wellbore after the step of introducing the treatment fluid into the wellbore.

9. The method of claim 8 wherein the hydrogel polymer further comprises polyvinyl pyrrolidone.

10. The method of claim 8 wherein the polysaccharide comprises a polysaccharide selected from the group consisting of: alginate, chitosan, cellulose, pectin, dextrin, starch, glycogen, and any combination thereof.

11. The method of claim 1 wherein the treatment fluid further comprises an acid.

12. The method of claim 11 wherein the hydrogel polymer further comprises polyvinyl pyrrolidone.

13. The method of claim 11 wherein the polysaccharide comprises a polysaccharide selected from the group consisting of: alginate, chitosan, cellulose, pectin, dextrin, starch, glycogen, and any combination thereof.

14. A method comprising:
providing a treatment fluid comprising a carrier fluid and a hydrogel polymer comprising the reaction product of a polysaccharide and a derivative of acrylic acid, wherein the hydrogel polymer further comprises polyvinyl pyrrolidone; and
introducing the treatment fluid into a wellbore that penetrates at least a portion of a subterranean formation, wherein the subterranean formation comprises a water-producing zone.

15. A composition comprising:
a carrier fluid comprising a fluid selected from the group consisting of: an acid, a non-aqueous fluid, a brine, and any combination thereof; and
a hydrogel polymer comprising the reaction product of a polysaccharide and a derivative of acrylic acid.

16. The composition of claim 15 wherein the hydrogel polymer further comprises polyvinyl pyrrolidone.

17. The composition of claim 15 wherein the polysaccharide comprises a polysaccharide selected from the group consisting of: alginate, chitosan, cellulose, pectin, dextrin, starch, glycogen, and any combination thereof.

18. The composition of claim 16 wherein the polysaccharide comprises a polysaccharide selected from the group consisting of: alginate, chitosan, cellulose, pectin, dextrin, starch, glycogen, and any combination thereof.

19. The composition of claim 15 wherein the hydrogel polymer further comprises a cross-linker.

20. The composition of claim 15 wherein the treatment fluid has a pH that is less than about 3.
